(19) United States
(12) Patent Application Publication
(10) Pub. No.: US 2006/0267547 A1
(43) Pub. Date: Nov. 30, 2006

(54) Replacement battery pack with built-in charging circuitry and power connector, and AC adapter for reading charging status of replacement battery pack

(76) Inventor: Mark Godovich, Brooklyn, NY (US)

Correspondence Address: ADAMS & WILKS, 17 BATTERY PLACE, SUITE 1231, NEW YORK, NY, 10004, US

(21) Appl. No.: 11/139,851

(22) Filed: May 27, 2005

(51) Int. Cl. H02J 7/00

(52) U.S. Cl. 320/107

(57) ABSTRACT

A replacement battery pack for an electronic device has a power storage section having a secondary battery. A power input section has at least one power connector for receiving electric power for charging the secondary battery while powering the electronic device. A power output/input section has an output terminal for receiving electric power from the power input section and for electrical connection to a connector of the electronic device to power the electronic device, and an input terminal for connection to an external power source for directly charging the secondary battery while the output terminal is disconnected from the connector of the electronic device. An input power switch circuit selectively inputs electric power to the power output/input section either from the power input section when the electric power is available therefrom or from the power storage section when the electric power is unavailable from the power input section.

### BACKGROUND OF THE INVENTION

1. Field of the Invention

The present invention relates to rechargeable power supplies for portable electronic devices and, more specifically, to a rechargeable replacement battery pack for a portable electronic device and which incorporates built-in charging circuitry and a power connector that is capable of charging a battery in the replacement battery pack while operating the portable electronic device. The present invention also relates to a customized AC adapter for reading a charging status of the replacement battery pack, and to a portable electronic device for use with the replacement battery pack and the customized AC adapter.

2. Background Information

A multitude of electronic devices have been developed which are convenient to carry. These types of electronic devices are generally referred to as portable electronic devices. There are two primary methods for supplying power to portable electronic devices. In one method, the power is supplied by an alternating current (AC) adapter. In the other method, the power is supplied by internal batteries.

One portable electronic device which has attained much popularity is the portable computer. The typical portable computer may include a laptop computer, notebook computer, and palmtop computer. These are compact, light weight and portable computing devices with substantial computing power and which are continually gaining popularity.

FIG. 14 shows a conventional portable computer 10. Direct current (DC) power for the portable computer 10 is either supplied by an internal battery, such as a rechargeable battery pack 12, housed within a battery pack receiving bay 14 formed in the portable computer 10, or from an AC adapter 16 connected to an external AC power source (not shown). The AC adapter 16 has an AC inlet cord 18 with an AC inlet connector 18a and a DC outlet cable 20 with a DC plug 22 for connection to a DC power jack 24 (DC power connector) of the portable computer 10 to charge the battery pack 12 and to operate the portable computer 10.

Power connectors and electronic components that feed power to electronic portable devices while charging a rechargeable battery pack tend to fail from time to time. For example, in conventional portable computers such as shown in FIG. 14, when the DC plug 22 is connected to the DC power connector 24 of the portable computer 10, DC power outputted from the AC adapter 16 drives the portable computer 10 while charging the internal battery 12. However, such conventional portable computers tend to experience significant DC power connector malfunction. As time goes by, some electronic components in a circuit, including a charging circuit, which includes the DC power connector 24 are damaged and interrupt the power flow in the circuit. In other cases the power connector 24 of the portable computer 10 breaks or burns, with the result that the portable computer 10 is no longer being powered and the internal battery 12 is no longer being charged by the charging circuit. In this case, when the charge remaining in the internal battery 12 is dissipated or too low to provide sufficient power for operating the portable computer 10, there is a great danger of data loss during operation of the portable computer 10.

One solution to this problem would require the user to stock two or more backup battery packs which must be charged externally with a charging apparatus and then alternatively inserted into the battery pack receiving bay 14 in order to supply continuous power to the portable computer. The provision of backup battery packs has an inconvenience in that the backup battery packs must be carried separately from the portable computer. Therefore, problems arise in that the backup battery packs are apt to be lost and damaged by careless handling.

Another solution is to repair the damaged power connector of the portable computer. However, repair of the damaged power connector is very expensive and time consuming since it requires disassembly of the portable computer. In many portable computers, the power connector cannot be repaired or replaced without removing or replacing the motherboard of the portable computer.

Several accessories have been proposed for charging a portable computer's internal battery without the necessity of using the portable computer's power connector. One of these accessories is commonly known as a docking station, which allows the portable computer to easily connect with fixed computer components thereby allowing it to operate as a conventional personal computer. The typical docking station is positioned on a table or desk and includes a base which is connected to several fixed computing components and peripherals such as a keyboard, printer, mouse, power source, monitor and in many circumstances, a computer network. The base includes docking connectors positioned to detachably secure a portable computer therein. When the portable computer is connected to the docking station, the fixed computer components and peripherals operate the portable computer. This permits the docking station to be used to charge the portable computer's internal battery.

Most computer docking stations are designed to minimize the amount of desk space they occupy. For example, some docking stations rest on a desk underneath a stand supporting the fixed monitor. To connect the portable computer to the docking station, the computer user rests the portable computer on the desk in front of the fixed monitor, then slides the portable computer under the monitor until the docking connectors of the portable computer connect with mating connectors on the docking station. Proper connection of these connectors requires them to be properly aligned with each other prior to their connection. One known device for ensuring the connectors are properly aligned prior to connection is to include a docking tray adjacent to the docking station. The tray usually includes slots that operably engage appropriately aligned protrusions extending from the bottom surface of the portable computer. Accordingly, the computer user positions the portable computer on the docking tray such that the protrusions engage the slots on the docking tray. In this configuration, the connectors on the docking tray and mating connectors on the portable computer are properly aligned. Then, the computer user slides the portable computer on the tray and toward the docking station, thereby connecting the portable computer to the docking tray.

These types of docking tray systems have several limitations. For example, they occupy a large amount of space on the desk when they are not in use. Similarly, aside from facilitating proper alignment of the personal computer with the docking station, they offer few other benefits.

Auxiliary batteries which increase the additional stored power for driving portable computers are known. Some auxiliary batteries are now light-weight and compact enough to be carried with a portable computer, thereby significantly increasing the portable computer's available stored power over that offered only by the portable computer's internal battery. However, these auxiliary batteries are typically connected to the power connector on the portable computer. Thus use of auxiliary batteries is rendered inoperable when the DC power connector of the portable computer malfunctions or is damaged.

Furthermore, despite the benefits offered by known auxiliary batteries, they have several drawbacks. For example, auxiliary batteries must be periodically recharged, and they usually occupy a significant amount of desk space while they are being recharged. In addition, since the personal computer and auxiliary battery are separate components that are electrically connected to each other by one or more cables, in some situations there is a tendency for them to move independently of each other. Such independent movement can lead to the two components becoming inadvertently disconnected from each other, or even to one or both of the components being damaged. For example, if a person using the portable computer with a conventional auxiliary battery attached is traveling in an airplane that encounters turbulence, the computer user may remember to hold their personal computer, thereby protecting it from damage. But he or she may forget that the auxiliary battery is attached and neglect to also hold the battery during the turbulence. Accordingly, the auxiliary battery could fall and possibly damage itself or injure someone.

Moreover, as noted above, portable computers, as well as other portable electronic devices, are provided with power adapters which supply power for recharging the batteries provided with the portable computers and for operating the portable computers. Conventional power adapters are typically provided with a pair of cords extending from a structure containing electrical circuitry for converting power input through one of the cords to a desired power level to be output through the other one of the cords to the portable computer. This type of conventional power adapter is inconvenient in that the structure containing the electrical circuitry can be bothersome, such as by continuously falling off of a table top or by being an obstruction. The cords provided with conventional power adapters are also inconvenient, particularly when they are substantially longer than is necessary for a particular application. The electrical power cord can become tangled either with itself or with other cords. When the power adapter is not in use, it is often necessary to coil up the cord and bind to the exterior of the power adapter in order to store the power adapter in a small space and to avoid having the cord become tangled.

The present invention overcomes many of the disadvantages inherent in conventional devices and methods for supplying power to portable electronic devices, such as portable computers.

### SUMMARY OF THE INVENTION

It is an object of the present invention to provide a replacement battery pack for portable electronic devices that can solve the problems associated with conventional portable electronic devices with inoperable power connectors and electronic components that feed power to the portable electronic devices.

It is another object of the present invention to provide a replacement battery pack configured to be received in the battery pack receiving bay of a portable electronic device in a detachable manner.

It is another object of the present invention to provide a replacement battery pack with a built-in charging circuitry and power connector that is capable of charging the electric power therein while operating a portable electronic device.

It is a further object of the present invention to provide a replacement battery pack with an integral power supply cord that is suitable for plugging into an AC power source, that is variable in length, and that retracts into a reel or spool enclosed in the replacement battery pack.

It is a further object of the present invention to provide a replacement battery pack wherein all components, including the built-in charging circuitry, batteries, and power connector, are integrated so that the size and shape of the replacement battery pack are the same as for a conventional battery pack for a portable electronic device and may be housed in and removed from a battery pack receiving bay of the portable electronic device without requiring alteration of the battery pack receiving bay or other part of the portable electronic device.

It is still a further object of the present invention to provide a customized AC adapter for connection to the replacement battery pack according to the present invention for reading a charging status of the replacement battery pack.

The foregoing and other objects of the present invention are carried out by a replacement battery pack comprising a power storage section having a secondary battery and a power input section having at least one power connector for receiving electric power for charging the secondary battery while powering an electronic device. A power output/input section has an output terminal for receiving electric power from the power input section and for electrical connection to a connector of the electronic device to power the electronic device, and an input terminal for connection to an external power source for charging the secondary battery while the output terminal is disconnected from the connector of the electronic device. An input power switch circuit selectively inputs electric power to the power output/input section either from the power input section when the electric power is available therefrom or from the power storage section when the electric power is unavailable from the power input section.

Preferably, the power connector of the power input section receives electric power either from an external direct current power source or a direct current power source converted from an external alternating current power source. Alternatively, the at least one power connector preferably comprises a first power connector for receiving electric power either from an external direct current power source or a direct current power source converted from an external alternating current power source, and a second connector for receiving electric power directly from an alternating current power source.

In a preferred embodiment, the replacement battery pack has an output/input control circuit for producing a power output at the output terminal of the power output/input section for powering the electronic device, and for producing a power input at the input terminal of the power output/input section for charging the secondary battery. A protection circuit protects the secondary battery by terminating a charge or discharge operation or disconnecting a charge or discharge operation when abnormal voltage and/or temperature is detected in the secondary battery. An indicator indicates remaining power in the secondary battery.

In another aspect, the present invention is directed to the foregoing described replacement battery pack in combination with a customized alternating current adapter for supplying a direct current power for charging the secondary battery while powering the electronic device by converting an alternating current power input into the alternating current adapter. The customized alternating current adapter has an alternating current plug for connection to an alternating current power source, a direct current plug for connection to the power connector of the power input section of the replacement battery pack, and a charge detecting circuit for detecting a charge state of the secondary battery in the replacement battery pack when the alternating current plug and the direct current plug are connected to the alternating current power source and the power connector, respectively. A display displays a charge state of the secondary battery detected by the charge detecting circuit.

In another aspect, the present invention is directed to a portable electronic device having a battery pack for supplying power to the portable electronic device and a battery pack receiving bay disposed within the portable computer for housing the battery pack. The battery pack receiving bay has a connector electrically connectable to the battery pack. A replacement battery pack is configured to be housed within or detached from the battery pack receiving bay. The replacement battery pack comprises a power storage section having a secondary battery, a power input section having at least one power connector for receiving electric power for charging the secondary battery, and a power output section having an output terminal for receiving electric power from the power input section and for electrical connection to the connector of the battery pack receiving bay when the replacement battery pack is housed in the battery pack receiving bay to power the portable electronic device. In one embodiment, the portable electronic device comprises a portable computer.

In another aspect, the present invention is directed to a replacement battery pack having a power storage section having a secondary battery. A power input section includes an alternating current power cord having an electrical plug at a first end for connection to an external alternating current power source and an electrical connector at a second end opposite the first end, an alternating current/direct current converter circuit connected to the electrical connector of the electrical plug for converting external alternating current power from the external alternating current power source to direct current power for charging the battery, and a reel on which the alternating current power cord is adapted to be wound and from which the alternating current power cord is adapted to be dispensed. A power output section has an output terminal for receiving electric power from the power input section and for electrical connection to a connector of a portable electronic device to power the portable electronic device. Preferably, the power output section has an input terminal for connection to an external power source for charging the secondary battery while the output terminal is disconnected from the connector of the portable electronic device.

### BRIEF DESCRIPTION OF THE DRAWINGS

The foregoing summary, as well as the following detailed description of preferred embodiments of the invention, will be better understood when read in conjunction with the accompanying drawings. For the purpose of illustrating the invention, there is shown in the drawings embodiments which are presently preferred. It should be understood, however, that the invention is not limited to the precise arrangement and instrumentalities shown. In the drawings:

FIG. 1A is a perspective view showing an embodiment of the replacement battery pack according to the present invention;

FIG. 1B is a diagram depicting the structure of a portable computer equipped with the replacement battery pack shown in FIG. 1A;

FIG. 2 is a block diagram showing the structure of the replacement battery pack shown in FIG. 1A;

FIG. 3 is a perspective view showing another embodiment of the replacement battery pack according to the present invention;

FIG. 4 is a block diagram showing the structure of the replacement battery pack shown in FIG. 3;

FIG. 5 is a perspective view showing another embodiment of the replacement battery pack according to the present invention;

FIG. 6 is a block diagram showing the structure of the replacement battery pack shown in FIG. 5;

FIGS. 7A-7B show another embodiment of the replacement battery pack according to the present invention, where FIG. 7A is a plan view showing an outer appearance of the replacement battery pack and FIG. 7B is a front view of the replacement battery pack shown in FIG. 7A;

FIG. 8 is a block diagram showing the structure of the replacement battery pack shown in FIGS. 7A-7B;

FIG. 9 is a schematic view showing a first usage of the replacement battery pack according to the present invention;

FIG. 10 is a schematic view showing a second usage of the replacement battery pack according to the present invention;

FIG. 11 is a perspective view showing an embodiment of a customized AC adapter according to the present invention;

FIG. 12 is a block diagram showing the structure of the customized AC adapter shown in FIG. 11;

FIG. 13 is a schematic view showing a usage of the customized AC adapter according to the present invention; and

FIG. 14 is a diagram depicting the structure of a prior art portable computer equipped with a conventional rechargeable battery pack and AC adapter.

### DETAILED DESCRIPTION OF THE PREFERRED EMBODIMENTS

While this invention is susceptible of embodiments in many different forms, this specification and the accompanying drawings disclose only examples of the use of the invention. The invention is not intended to be limited to the embodiments so described, and the scope of the invention will be pointed out in the appended claims.

The preferred embodiments of the rechargeable replacement batteries and the customized AC adapter according to the present invention are described below with a specific application to a portable computer, such as laptop, notebook and palmtop computers. However, it will be appreciated by those of ordinary skill in the art that the present invention is also well adapted for other portable electronic devices having a battery pack receiving bay for housing a battery pack, such as cellular phones, audio/video devices, power tools, electric shavers and the like.

Certain terminology is used in the following description for convenience only and is not intended to be limiting. The words right, front, rear, bottom and outwardly designate directions in the drawing to which reference is made. Such terminology includes the words above specifically mentioned and words of similar import.

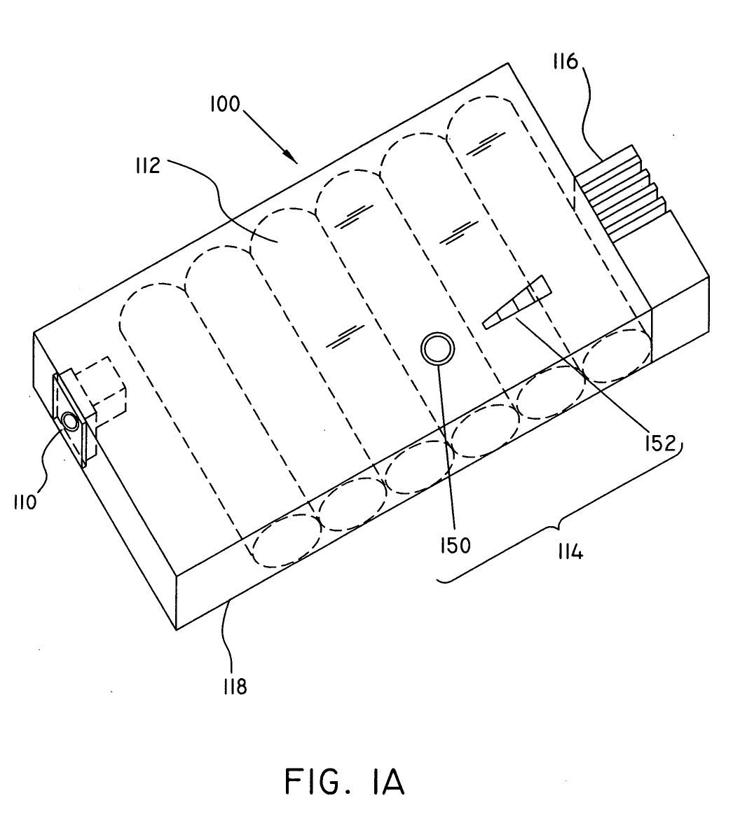

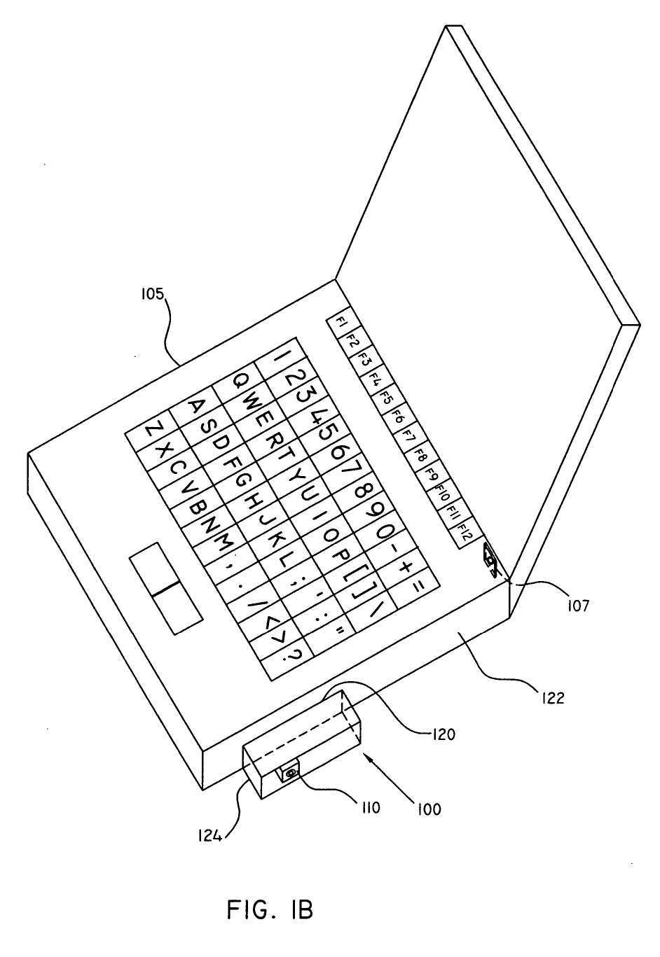

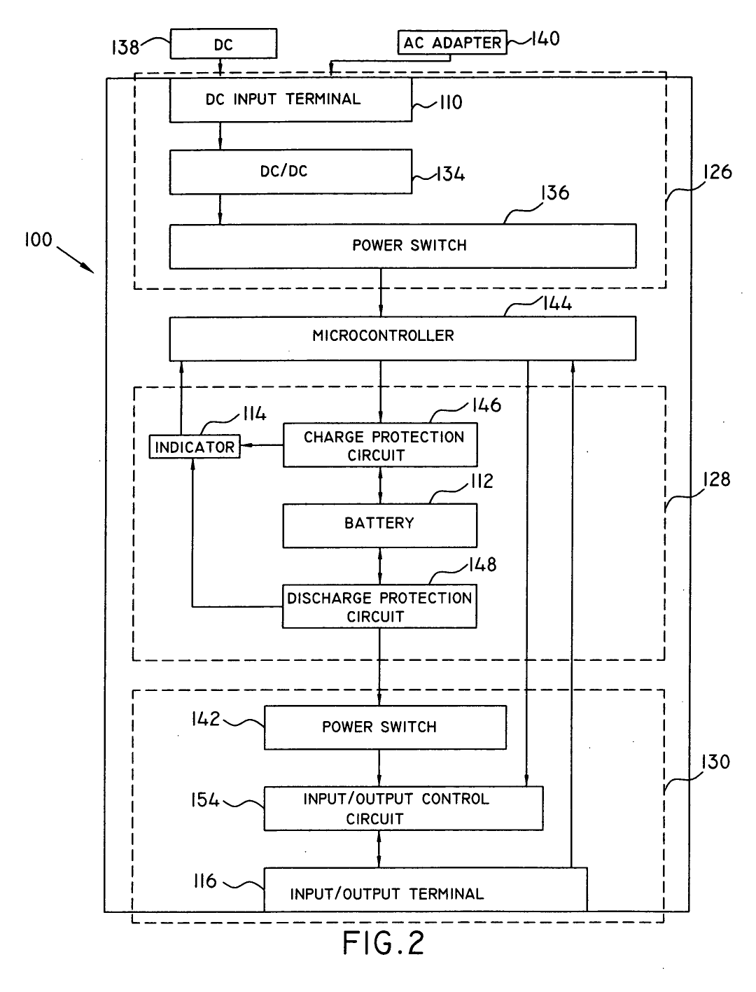

Referring now to the drawings in detail, wherein like numerals are used to indicate like elements throughout, there is shown in FIGS. 1A-1B and 2 an embodiment of a rechargeable replacement battery pack, generally designated at 100, according to the present invention for providing direct current (DC) power to a portable electronic device, such as a portable computer 105. As shown in FIG. 1A, the replacement battery pack 100 has a power connector in the form of a DC input terminal or socket 110, a battery 112 such as a secondary battery, a capacitor indicator 114 for displaying a remaining capacity in the battery 112, and a connector 116 designed for electrical connection to a connector in the battery pack receiving bay of a portable computer. The foregoing components, as well as other components further described below, of the replacement battery pack 100 are integrated with and/or within a housing 118 and assembled in any of a variety of ways as is conventionally known by those skilled in the art. For example, the replacement battery pack 100 may be assembled by holding the components in proper relationship in a mold and then casting a cross-linkable resin around them, or by holding the components in a suitable jig and then wrapping a heat-shrinkable polymer film around them to form the housing 118. Accordingly, further specifics of the various methods for manufacturing the replacement battery pack 100 are omitted.

FIG. 1B shows the replacement battery pack 100 used in a portable computer 105 having a power connector 107. The replacement battery pack 100 is configured such that is may be housed or detached from a receiving bay 120 of a conventional battery pack in the portable computer 105. Preferably, the replacement battery pack 100 has the same external shape and size as the conventional battery pack of the portable computer 105. Thus, the replacement battery pack 100 may be used with the portable computer 105 (i.e., housed or detached from the receiving bay 120) without requiring alteration of the battery pack receiving bay 120 or any other part of the portable computer 105.

In the embodiment shown in FIG. 2, the opening of the receiving bay 120 is disposed at a side 122 of the portable computer 105 and a front portion 124 of the replacement battery pack 100 protrudes outwardly from the side 122. The length of the replacement battery pack 100 is greater than the conventional battery pack in order to accommodate the power connector(s) and built-in charging circuitry as further described below. However, it is understood that even if the length of the replacement battery pack 100 is greater than the length of the conventional battery pack of the portable computer 105, as in the case of the embodiment shown in FIGS. 1A-1B, the replacement battery pack 100 may be housed or detached from the receiving bay 120 without requiring structural modification of the portable computer 105. It is also understood by those skilled in the art that use of the replacement battery pack 100 is not limited to portable computers in which the battery pack receiving bay is accessible from a side of the portable computer, but is also adapted for use with portable computers in which the battery pack receiving bay is accessible from the front or rear of the portable computer.

The structure and function of the connector 116 of the replacement battery pack 100 are the same as for a conventional battery pack used for portable computers. When the replacement battery pack 100 is housed in the battery pack receiving bay 120 of the portable computer 105, the connector 116 is electrically connected to a connector provided in the battery pack receiving bay 120 to form appropriate electrical connection and functions as an output terminal for providing power to the portable computer 105. When the replacement battery pack 100 is detached from the battery pack receiving bay 120 of the portable computer 105, the connector 116 of the replacement battery pack 100 can be electrically connected to corresponding connectors of a charging station and functions as an input terminal for charging the replacement battery pack in a conventionally known manner.

It will be appreciated that the replacement battery pack 100 of the present invention is adapted to replace the conventional battery pack typically used with the portable computer 105 when the power connector 107 of the portable computer 105 is rendered inoperable. As further described below in detail, the replacement battery pack 100 incorporates a built-in charging circuity and a power connector(s) by which the portable computer 105 may be powered by an external DC power source connected directly to the replacement battery pack 100 or by the battery 112 of the replacement battery pack 100 which is charged by the DC power source. Thus, even when the power connector 107 of the portable computer 105 is inoperable, the portable computer 105 can be operated normally without the necessity of repairing or replacing the power connector 107.

It will also be appreciated by those skilled in the art that the replacement battery pack 100 is not limited to use with the portable computer 105 only when the power connector 107 of the portable computer 105 is inoperable. Even if the power connector 107 is fully operable, the replacement battery pack 100 may be used with the portable computer 105 as an alternative means for supplying power to the portable computer 105, or when it is more convenient to have a power cable extend from the power connector of the replacement battery pack 100 (i.e., from the side 122 of the portable computer 105) rather than from the power connector 107 (i.e., from the rear of the portable computer 105).

FIG. 2 is a block diagram showing the internal structure of the replacement battery pack 100 shown in FIGS. 1A-1B. The replacement battery pack 100 is comprised of a power input section 126, a power storage section 128, and a power input/output section 130 for connection to the portable device 105. The power input section 126 provides electric power from external power sources to the power input/output section 130 and/or power storage section 128. The power input section 126 includes the DC input terminal 110, a DC/DC converter circuit 134, and an output power switch circuit 136 (first power switch circuit). The DC input terminal 110 receives DC electric power from external DC sources. For example, these external DC sources include a DC power source 138, such as from an automobile cigarette lighter socket, and an alternating current (AC) adapter 140. It is understood by those skilled in the art that the AC adapter may be a conventional one which is adapted for portable electronic devices and which is connected to an alternating current power source such as a commercial power source. The DC/DC converter circuit 134 outputs various levels of DC voltages required for use in the portable computer 105 and for charging the secondary battery 112 in the power storage section 128 by converting the DC electric power supplied to the DC input terminal 110. Preferably, the DC input terminal 110 receives DC electric power with a voltage range of, for example, 16-20 volts, from the external power sources.

The output power switch circuit 136 provides the DC power received from the DC/DC converter circuit 134 to an input power switch circuit 142 (second power switch circuit) in the power input/output section 130 for powering the portable computer 105 and to the power storage section 128 for charging the secondary battery 112. The output power switch circuit 136 provides the DC power to the input power switch circuit 142 via a control circuit or microcontroller 144 which is further described below. Any excess DC power that occurred when supplying the DC power to the input power switch circuit 142 is supplied to the power storage section 128. In the present invention, the output power switch circuit 136 gives priority to the input power switch circuit 142 over the power storage section 128 in supplying the power. Therefore, when the power input/output section 130 of the replacement battery pack 100 is connected to the connector in the battery pack receiving bay of the portable device 105 (i.e., when the replacement battery pack 100 is inserted in the battery pack receiving bay 120), the power from the power input section 126 is supplied to the power switch circuit 142 to drive the portable device 105. However, when the portable computer 105 is not connected to the power output section 130, the DC electric power from the power input section 126 is used to charge the power storage section 128.

The power storage section 128 is comprised of the microcontroller 144, the battery 112, and a protection circuit. The power storage section 128 is disposed between the power input section 126 and the power input/output section 130 and stores the electric power by charging the excess power in the battery 112.

The microcontroller 144 controls the current flow between the external power sources, the battery 112 and the portable computer 105. The microcontroller 144 also controls a charge operation of the battery 112 by converting or adjusting the charge conditions to be suitable for charging the battery 112 by the power received from the output power switch circuit 136 of the power input section 126. The charge conditions include, for example, adjustment and control of charge voltage and current, start control of the charge operation, and a stop control after detection of full charge.

The protection circuit is comprised of a charge protection circuit 146 and a discharge protection circuit 148 and is arranged between the output power switch circuit 136 of the power input section 126 and the input power switch circuit 142 of the power input/output section 130. The protection circuit protects the replacement battery pack 100 by terminating the charge and discharge operation of the battery 112 when an abnormal temperature or voltage is detected. The charge protection circuit 146 is disposed between the microcontroller 144 and the battery 112 and functions to terminate the charge operation when detecting any abnormalities in charging the battery 112, such as over charging or temperature increase. The discharge protection circuit 148 is disposed between the battery 112 and the input power switch circuit 142 and functions to terminate the discharge operation when detecting any abnormalities in discharging the battery 112 such as over discharging or temperature increase. The charge protection circuit 146 and the discharge protection circuit 148 accumulate the current and voltage during the charge and discharge operation of the battery 112.

The battery 112 is connected between the charge protection circuit 146 and the discharge protection circuit 148 and stores the electric power by charging the power from the power input section 126 which is surplus power when providing the power to the power input/output section 130. When the power supplied to the power input/output section 130 which is connected to the portable computer 105 is insufficient, the battery 112 provides supplemental power to the input power switch circuit 142 of the power output section 130 through the protection circuit.

The capacitor indicator 114 receives and displays a remaining capacity in the battery 112 in accordance with the current and voltage accumulated by the charge protection circuit 146 and the discharge protection circuit 148 during the charge and discharge operation of the battery 112. It is understood by those skilled in the art that any known capacitor indicator may be incorporated in the replacement battery pack 100 of the present invention. In the embodiment shown in FIG. 1A, the capacitor indicator 114 comprises a switch 150 and an LED indicator 152 for displaying different levels of the remaining capacity in the battery 112.

Referring back to FIG. 2, the power input/output section 130 is comprised of the input power switch circuit 142, an input/output control circuit 154, and the connector 116 in the form of an input/output terminal. The power output section 130 outputs the electric power received from the power input section 126 or from the power storage section 128 to the portable computer 105 when the input/output terminal 116 is electrically connected to the connector in the receiving bay 120 of the portable computer 105. In this case, the input/output terminal 116 functions as an output terminal for outputting the electric power to the portable computer. Thus, during a normal mode, the input power switch 142 provides the electric power from the external power source (e.g., DC source 138 or AC adapter 140) to the input/output control circuit 154 via the output power switch circuit 136 and microcontroller 144. However, when the supply of electric power through the output power switch circuit 136 is stopped or insufficient due to, for example, the power failure in the external power source, the battery 112 supplies additional power to the input/output control circuit 154.

Alternatively, the input/output terminal 116 is also configured for connection to a corresponding connector of a charging station for charging the battery 112 of the replacement battery pack 100 externally (i.e., when the replacement battery pack 100 is not housed in the receiving bay 120 of the portable computer 105). In this case, the replacement battery pack 100 can be charged externally in a manner similar to the way a conventional battery pack for a portable computer is charged. Thus, it will be appreciated by those skilled in the art that the input/output terminal 116 of the replacement battery pack 100 functions as both an input terminal (i.e., for charging the battery 112) and an output terminal (i.e,. for supplying DC power to the portable computer 105).

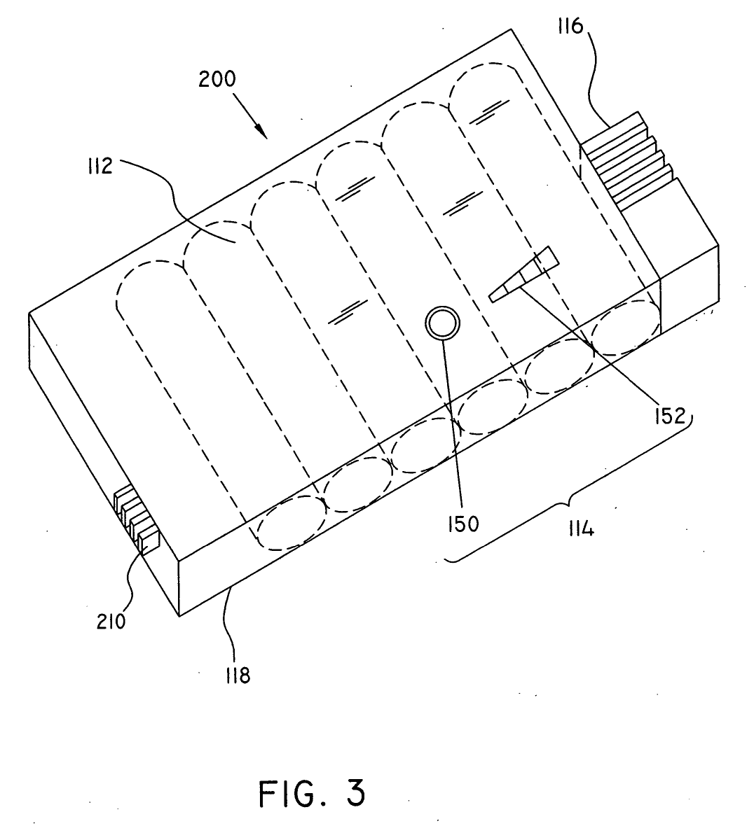

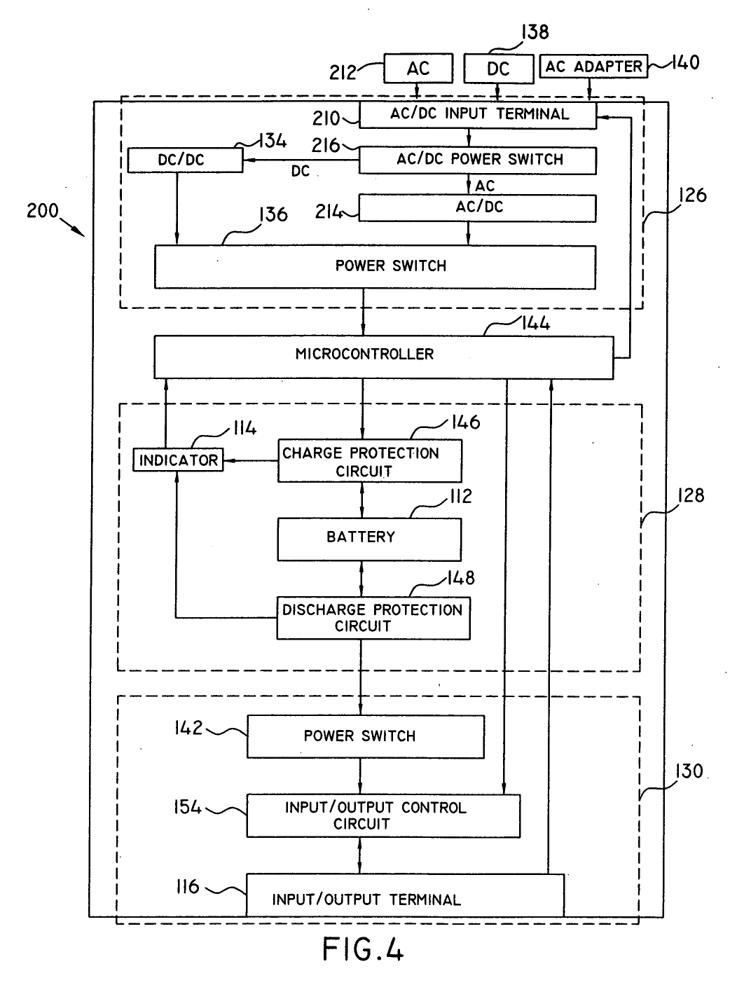

FIGS. 3-4 show another embodiment of a replacement battery pack 200 according to the present invention. The structure and function of the replacement battery pack 200, including the battery 112, power switches 136, 142, microcontroller 144, charge protection circuit 146, discharge protection circuit 148, input/output control circuit 154 and input/output terminal 116, are generally the same as described above for the replacement battery pack 100, except as further described below. For ease of understanding, the same numerals used with reference to the replacement battery pack 100 will be used to describe the corresponding components of the replacement battery pack 200.

As shown in FIG. 3, the replacement battery pack 200 differs from the replacement battery pack 100 in that it has a built-in power connector in the form of an alternating current (AC) and direct current (DC) input terminal (AC/DC input terminal) 210 rather than the DC input terminal 110. The replacement battery pack 200 also has the battery 112, the capacitor indicator 114 for displaying a remaining capacity in the battery 112, the connector 116 designed for electrical connection to a portable computer, and the housing 118, all as described above for the replacement battery pack 100.

FIG. 4 is a block diagram showing the internal structure of the replacement battery pack 200 shown in FIG. 3. Similar to the replacement battery pack 100, the replacement battery pack 200 is comprised of a power input section 126, a power storage section 128, and a power input/output section 130 for connection to the portable device 105. The only structural difference between the replacement battery pack 200 and the replacement battery pack 100 is in the power input section 126 and its connection to the microcontroller 144. More specifically, instead of the DC input terminal 110, the replacement battery pack 200 has the AC/DC input terminal 210 which can receive AC power with a voltage range of, for example, 100-240V supplied from an AC power source 212 (e.g., an AC wall outlet), such as domestic or foreign AC power sources. The AC electric power that is input to the AC/DC input terminal 210 is converted to DC electric power by an AC/DC converter circuit 214, thereby providing the DC power for operating the portable computer.

Alternatively, the AC/DC input terminal 210 can receive DC current electric power from external DC power sources, such as DC power source 138 and AC adapter 140, as set forth above for the replacement battery pack 100. The replacement battery pack 200 is also provided with an AC/DC power switch 216 for performing a switching operation depending upon the source currently powering the replacement battery pack 200. For example, when the replacement battery 200 is plugged into an AC wall outlet or when it otherwise begins to operate using AC power, the AC power is directed to the AC/DC converter circuit 214 by a switching operation of the AC/DC power switch 216. Alternatively, when the replacement battery pack 200 begins to operate using DC power (e.g., via a DC source or an AC adapter), the DC power is directed to the DC/DC converter circuit 134 which in turn outputs various levels of DC voltages required for use in the portable computer 105 by converting the DC power supplied to the AC/DC input terminal 210. Thus the function of the AC/DC power switch 216 is to determine how to direct the flow of the current, whether it needs to be converted into a DC power (i.e., via the AC/DC converter circuit 214) or whether it is a DC power and needs to be converted into a specific voltage (i.e., via the DC/DC converter circuit 134).

According to another feature of the present invention, the AC/DC input terminal 210 of the replacement battery pack 200 also functions as an output for outputting a charging status of the battery 112 to a customized AC adapter upon connection of the customized adapter to the AC/DC input terminal 210. The customized adapter constitutes another aspect of the present invention and will be described in detail below.

As described above for the replacement battery pack 100, the capacitor indicator 114 receives and displays a remaining capacity in the battery 112 in accordance with the current and voltage accumulated by the charge protection circuit 146 and the discharge protection circuit 148 during the charge and discharge operation of the battery 112. The capacitor indicator 114 also outputs the remaining capacity in the battery 112 to the microcontroller which in turns outputs the remaining capacity to the AC/DC input terminal 210. By this construction, when the customized AC adapter is plugged into the AC/DC input terminal 210, a charging status of the battery 112 is readily obtained. This is particularly useful when the replacement battery pack 200 is housed in the battery pack receiving bay of the portable computer, in which case the switch 150 and the LED indicator 152 of the battery 112 for displaying different levels of the remaining capacity in the battery 112 are not accessible to the user.

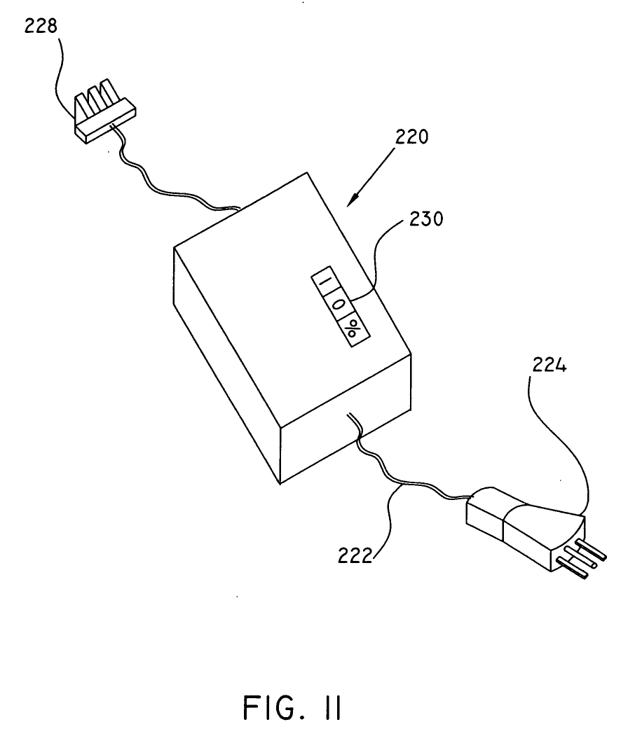

FIGS. 11-13 show an embodiment of the customized AC adapter, generally designated at 220, according to the present invention. As shown in FIG. 11, the customized AC adapter 220 has an AC inlet cable 222 with an AC plug 224 for connection to the AC power source 212 (e.g., a wall outlet), and a DC outlet cable 226 with a DC plug 228 for connection to the AC/DC input terminal 210 of the replacement battery pack 200. An indicator 230 displays different levels of the remaining capacity in the battery 112 when the DC plug 228 is connected to the AC/DC input terminal 210 of the replacement battery pack 200. As further described below, when connected to the AC/DC input terminal 210 of the replacement battery pack 200, the customized AC adapter 220 functions as a conventional AC adapter and supplies DC power for driving the portable computer and/or charging the battery 112.

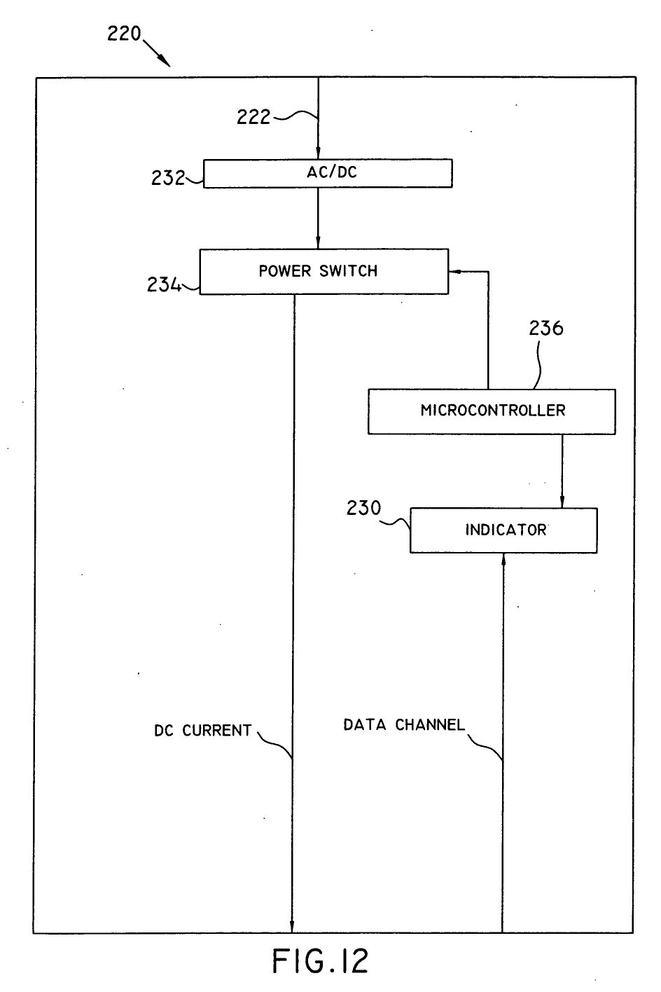

FIG. 12 is a block diagram showing the structure of the customized AC adapter 220. The AC inlet cable 222 is connected to an AC/DC converter circuit 232 for converting AC electric power into DC electric power for operating the portable computer and/or charging the battery 112 via a power switch circuit 234 which controls the flow of the DC power generated by the AC/DC converter circuit 232. As described above, the capacitor indicator 114 receives and displays a remaining capacity in the battery 112 in accordance with the current and voltage accumulated by the charge protection circuit 146 and the discharge protection circuit 148 during the charge and discharge operation of the battery 112. The capacitor indicator 114 outputs a signal to the microcontroller 144 containing data corresponding to the remaining capacity in the battery 112. The microcontroller 144 then in turn outputs the remaining charge capacity data to the AC/DC input terminal 210.

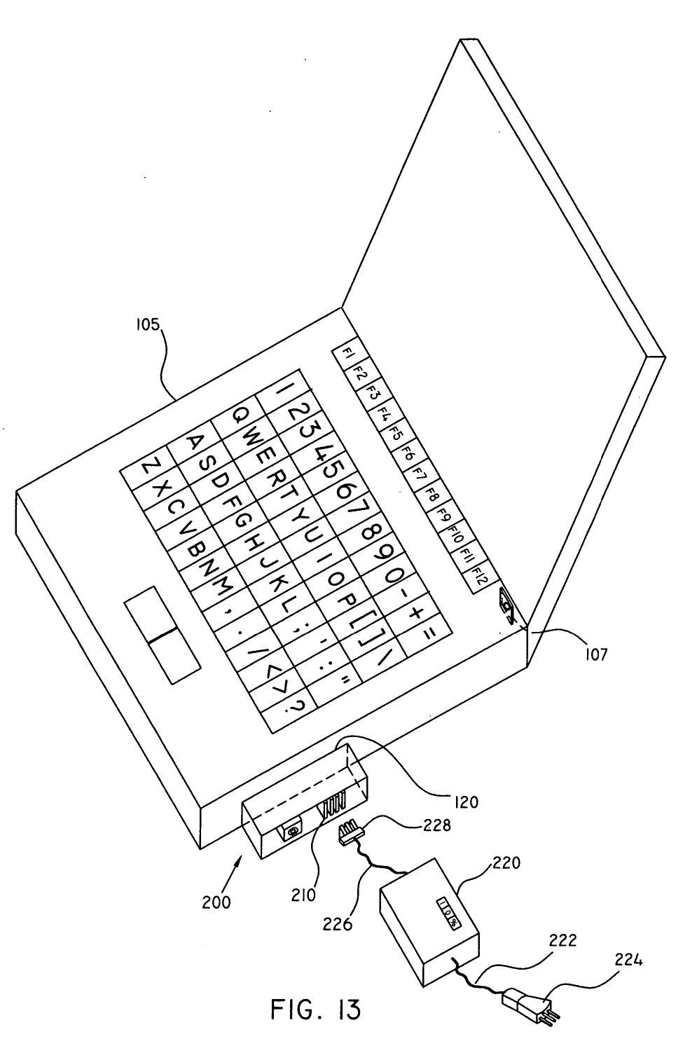

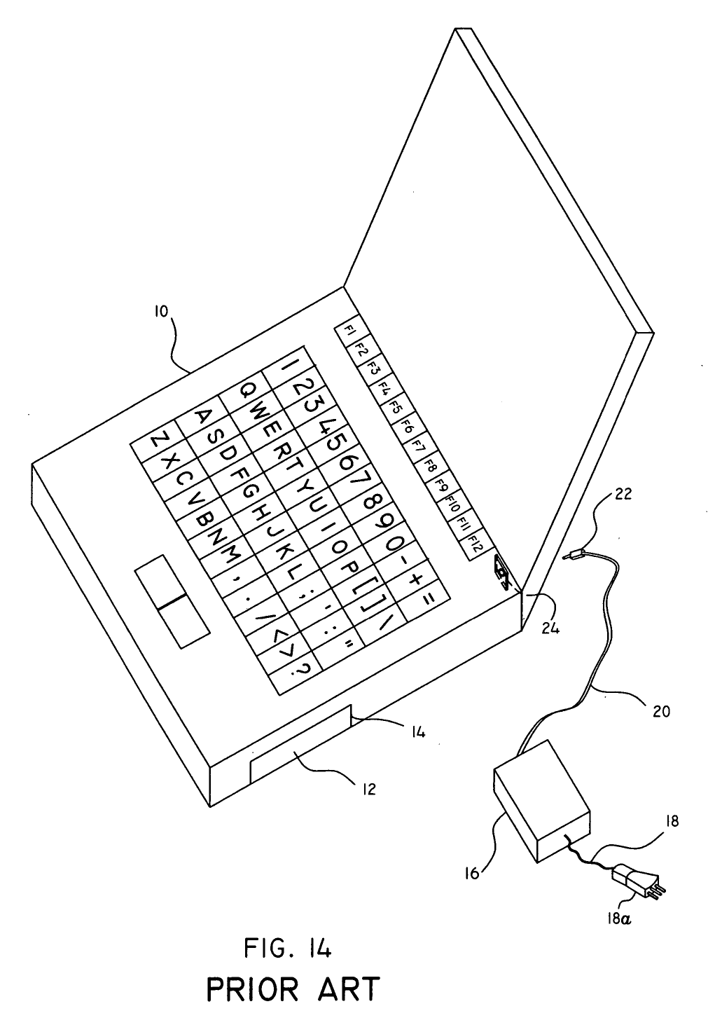

FIG. 13 is a schematic view showing a usage of the customized AC adapter 220. With reference to FIGS. 12 and 13, when the DC plug 228 of the customized AC adapter 220 is connected to the AC/DC input terminal 210 of the replacement battery pack 200, the remaining charge capacity data is detected by the customized AC adapter 220. At this point, the remaining charge capacity data is inputted into a microcontroller 236 of the customized AC adapter 220 via a data channel line. The microcontroller 236 then outputs a signal corresponding to the remaining charge capacity data to the indicator 230 for displaying the remaining charge of the battery 112. The microcontroller 236 also controls the power switch circuit 234 to conduct corresponding switching operations for controlling the flow of DC power to the AC/DC input terminal 210 of the replacement battery pack 200 depending on whether the remaining charge capacity data of the battery 112 received by the microcontroller 236 indicates that the battery 112 has a full charge or requires further charging.

In the embodiment shown in FIGS. 11-13, the indicator 230 comprises, for example, an LED indicator for displaying different levels (e.g., in the form of a percentage) of the remaining capacity in the battery 112. It will be appreciated by those skilled in the art that although FIG. 13 shows the customized AC adapter 220 in use while the replacement battery pack 200 is housed in the battery pack receiving bay 120 of the portable computer 105, the customized AC adapter 220 can also be connected to the replacement battery pack 200 while the replacement battery pack 200 is removed from the battery pack receiving bay 120. In this case, the customized AC adapter 220 will function to detect and display a charging status of the battery 112 and supply the DC power for charging the battery 112, if necessary.

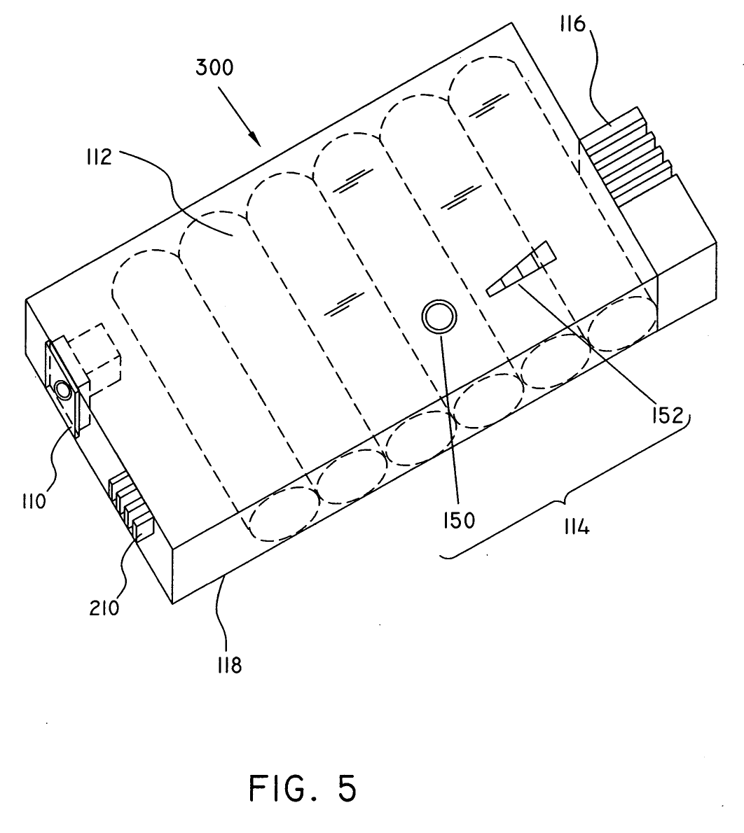

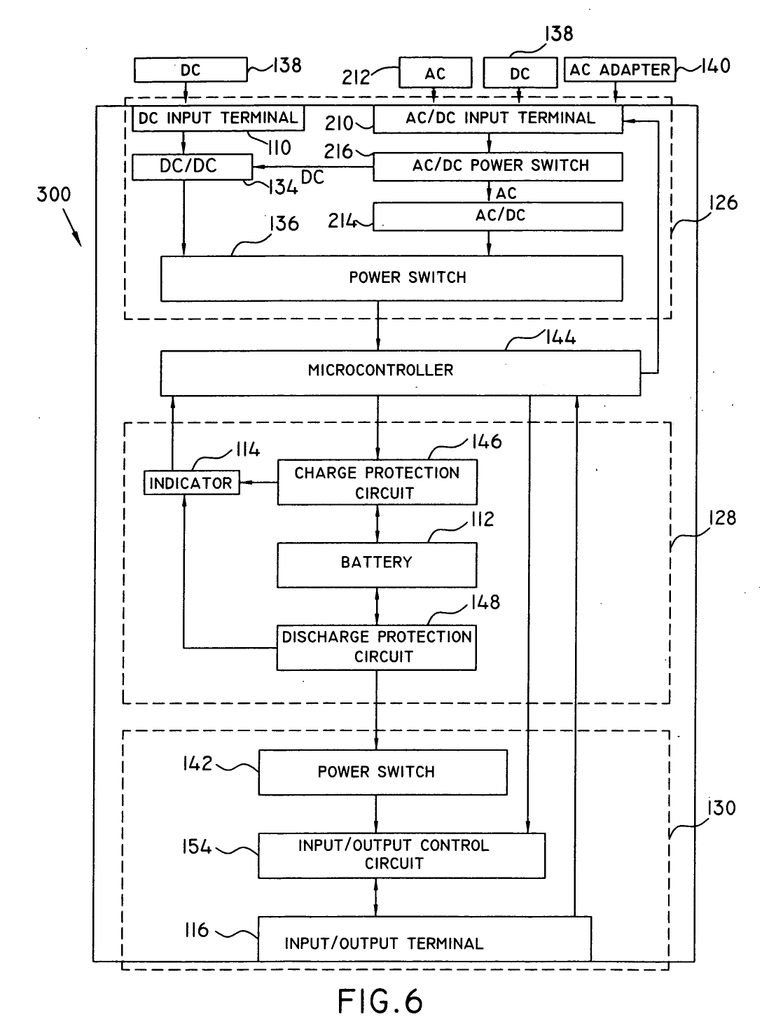

FIGS. 5-6 show another embodiment of a replacement battery pack 300 according to the present invention. The replacement battery pack 300 differs from the embodiments of the replacement batteries 100 and 200 described above in that the replacement battery pack 300 incorporates the built-in charging circuitry and power connectors (e.g., DC input terminal 110 and AC/DC input terminal 210) of both of the replacement batteries 200 and 300. The remaining structure and function of the replacement battery pack 300, including the structure and function of the battery 112, capacitor indicator 114, connector (input/output terminal) 116, housing 118, power switches 136, 142, microcontroller 144, charge protection circuit 146, discharge protection circuit 148, and input/output control circuit 154, are the same as described above for the replacement batteries 100 and 200. Additionally, in this embodiment, the DC/DC converting circuit 134 is connected between the DC input terminal 110 and the input power switch circuit 136, and is connected to the AC/DC power switch circuit 216 for performing the switching operation as described above for the replacement battery pack 200.

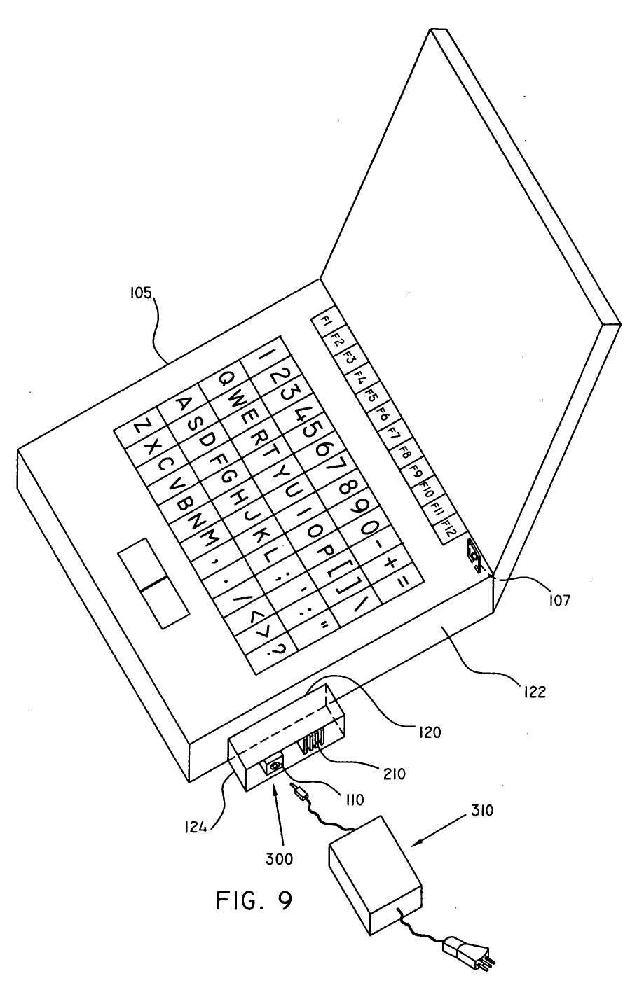

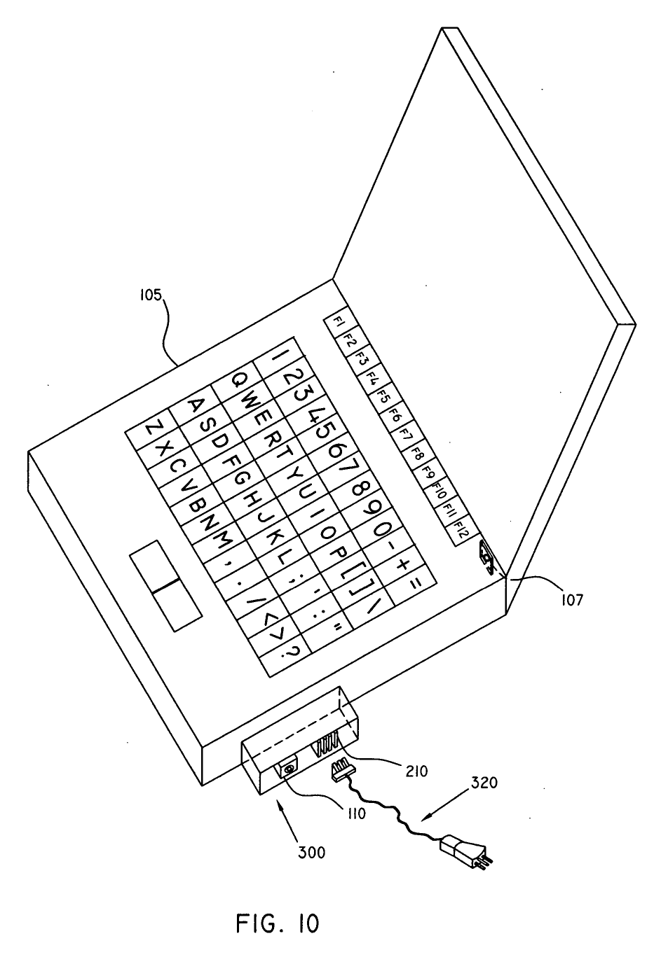

FIGS. 9-10 show two different ways of supplying power to the replacement battery pack 300 when the replacement battery pack 300 is housed in the battery pack receiving bay 120 of the portable computer 105 shown in FIG. 1B. In FIG. 9, a conventional AC adapter 310, which is powered by any conventionally known AC power source (not shown) may be plugged directly into the DC input terminal 110 of the replacement battery pack 300 for supplying DC power to the replacement battery pack 300 to drive the portable computer 105 and, if necessary, charge the replacement battery pack 300 via the built-in charging circuitry of the replacement battery pack 300. In FIG. 10, a conventional AC power cable 320 may be plugged directly into the AC/DC input terminal 210 of the replacement battery pack 300 for supplying the necessary AC power which is converted to DC power by the AC/DC converter circuit 214 for driving the portable computer 105 and, if necessary, charge the replacement battery pack 300 via the built-in charging circuitry of the replacement battery pack 300.

It will be appreciated by those skilled in the art that the customized AC adapter 220 described above with reference to the embodiment of FIGS. 11-13 is also adapted for use with the replacement battery pack 300. The manner of connecting the customized AC adapter 220 to the replacement battery pack 300 and its use with the replacement battery pack 300 are the same as described above for the replacement battery pack 200.

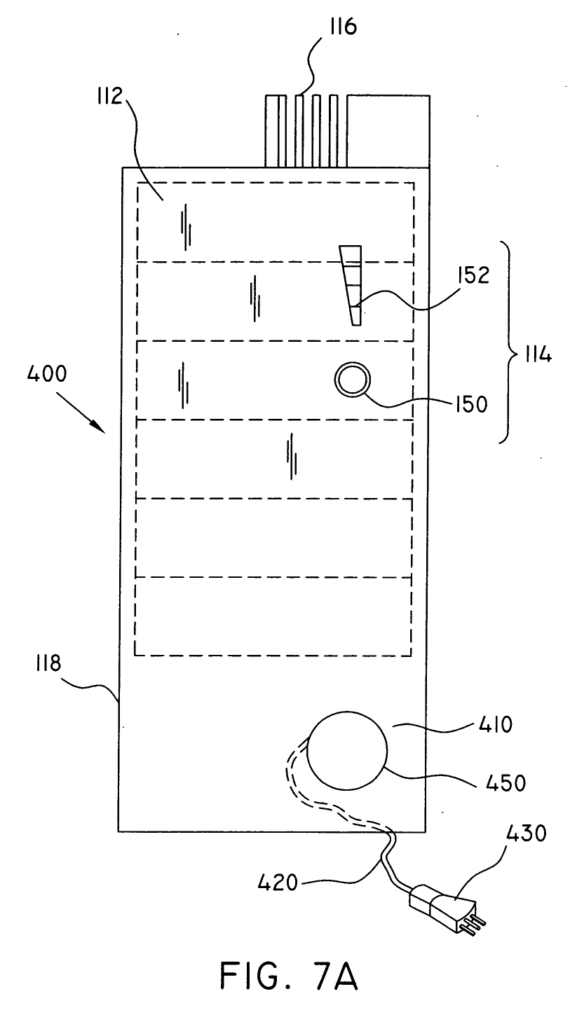

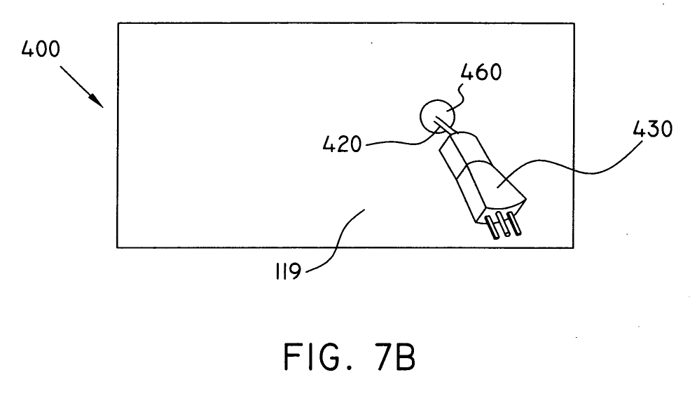

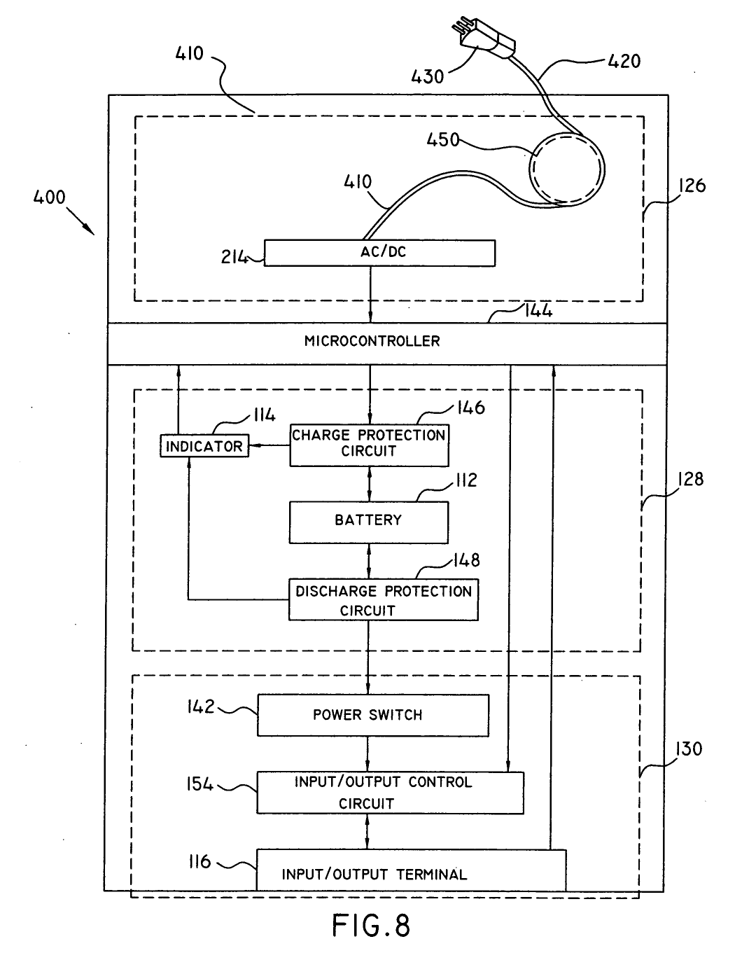

FIGS. 7A-7B and 8 show another embodiment of a replacement battery pack 400 according to the present invention. The replacement battery pack 400 has all of the components described above for the replacement battery pack 300 except for the DC input terminal 110, DC/DC converting circuit 134, AC/DC input terminal 210, AC/DC power switch 216, and input power switch circuit 136. In this embodiment, the casing 118 has a compartment 410 for storing a retractable electrical power cord 420 for providing electrical power to the replacement battery pack 400. The electrical power cord 420 has a male electrical plug 430 for connection to an AC power source (e.g., an AC wall outlet) and an electrical connector 440 for electrical connection to the AC/DC converter circuit 214 which is housed in the casing 118 of the replacement battery pack and which converts the AC power from the AC power source to a power level (DC power) suitable for powering the portable computer. The electrical power cord 420 extends from the electrical connector 440, through an aperture 460 formed in a front end 119 of the replacement battery pack 400, and to the exterior of the replacement battery pack 400 and terminates in the male electrical plug 430. The dimensions of the male electrical plug 430 are selected so that the electrical plug 420 does not pass through the aperture 460 and is not inserted into the compartment 410 of the replacement battery pack 400 when the electrical power cord 420 is retracted into the compartment 410.

The compartment 410 also includes a spool or reel 450 on which the electrical power cord 420 is adapted to be wound and from which the electrical power cord 420 is adapted to be dispensed. The reel 450 may include a handle or crank or other means for manually rewinding the electrical power cord 420 onto the reel 450. U.S. Pat. No. 5,923,147, which is incorporated by reference, shows a cord reel including grooves for manually rewinding the cord onto the reel, and is one example of a manual cord reel that is suitable for use in connection with the present invention.

Alternatively, the reel 450 preferably includes a spring-loaded drive for automatically rewinding the electrical power cord 420 onto the reel 450. Spring-loaded drives for rewinding cords on reels are common in various corded devices and appliances, such as seen from U.S. Pat. No. 6,082,656, which is incorporated by reference, and are similarly suited for use in connection with the present invention. At least one of the reel 450 and the spring-loaded drive includes a suitable lock, such as a ratchet, for preventing the spring-loaded drive from automatically rewinding the electrical power cord 420 onto the reel 450 until a user releases the lock.

The replacement battery pack 400 is adapted for use with the portable computer 105 as described above for the replacement batteries 100-300. During use, the replacement battery pack 400 is inserted into the battery pack receiving bay 120 of the portable computer 105. The electrical power cord 420 is then retracted from the compartment 410 by rewinding the reel 450 either manually, if the reel has a manual handle or crank, or by pulling the electrical power cord 420 against a spring force, if the reel has a spring-loaded drive, and extended to a desired length to allow connection of the electrical plug 430 into an AC power source (e.g., AC wall outlet). The AC power from the AC power source is then converted by the AC/DC converter circuit 214 into a suitable DC power for driving the portable computer 105 or charging the battery 112 of the replacement battery pack 400. Once the need for power is over, the user merely disconnects the electrical plug 430 from the AC power source and winds the electrical power cord 420 onto the reel 450. This is accomplished manually if the reel 450 has a manual handle or crank, or, if the reel 450 has a spring-loaded drive, by pulling the electrical power cord 420 out slightly and letting it wind onto the reel 450 and retract into the compartment 410 of the casing 118.

It is understood by those skilled in the art that the integration of a retractable electrical power cord for providing electrical power to the replacement battery pack is not limited to the embodiment of the replacement battery pack 400. In this regard, the retractable electrical power cord may be incorporated into any one of the foregoing embodiments of the replacement batteries 100-300 so long as appropriate accommodation is provided in the casings of the replacement batteries. For example, the retractable electrical power cord is also suitable for integration with the replacement battery pack 100 by mounting the reel and AC/DC converter circuit adjacent (right side in FIG. 2) to the DC input terminal 110.

Thus the present invention provides a replacement battery pack with a retractable electrical power cord that is suitable for plugging into an AC power source (e.g., AC wall outlet) to power the replacement battery pack, that is variable in length, and that retracts-into a spool or reel enclosed in the casing of the replacement battery pack after use. By incorporating the retractable electrical power cord in the replacement battery pack of the present invention as described above, the inconvenience of the electrical power cord becoming tangled either with itself or with other cords is eliminated since only the necessary amount of electrical power cord is retracted from the casing of the replacement battery pack. Furthermore, when the replacement battery pack is not in use, it is not necessary to coil up the electrical power cord and bind it to the exterior of or adjacent to the replacement battery pack, thereby permitting the storage of the replacement battery pack in a small space.

From the foregoing description, it will be apparent that in the replacement battery pack according to the present invention all of the components are incorporated into and/or integrated with the casing of the replacement battery pack which is shaped and dimensioned to be housed and removed from a battery pack receiving bay of a portable electronic device, such as a portable computer. Thus the replacement batteries of the present invention are well adapted for use with existing portable electronic devices which include a battery pack receiving bay without modification of battery pack receiving bay or other part of the portable devices.

The replacement batteries according to the present invention also provide a quick and simple solution for supplying power to portable electronic devices, such as portable computers, which have inoperable power connectors. This is made possible by the built-in charging circuitry and power connector(s) and/or retractable electrical power cord of the replacement batteries of the present invention which can be electrically connected directly to an AC or DC power source to charge the battery and drive the portable electronic device (e.g., portable computer), to which the replacement battery pack is connected (e.g., housed in the battery pack receiving bay of the portable electronic device).

It will also be appreciated, however, that the replacement batteries of the present invention are not limited to use with a portable electronic device only when the power connector of the portable electronic device is inoperable. Even if the power connector of the portable electronic device is fully operable, the replacement batteries may be used with the portable electronic device as an alternative means for supplying power to the portable electronic device, or when it is more convenient to have a power cable extend from the power connector of the replacement battery pack rather than from the power connector of the portable electronic device. It will also be appreciated that use of the replacement batteries of the present invention is not limited to electronic devices of the portable type, but to electronic devices in general which have a receiving bay for a battery pack for supplying power to the electronic device.

While the foregoing embodiments of the replacement battery pack of the present invention have been described for use with portable computers having battery pack receiving bays accessible from front, rear and sides of the portable computer, these embodiments are no so limited. For example, as described above, the replacement batteries of the present invention may also be used with portable computers having battery pack receiving bays which are accessible from the bottom surface (i.e., a normally resting surface) of the portable computer. In this case, it will be appreciated by those skilled in the art that the replacement battery pack can be readily modified to incorporate the power connector(s) on the exposed major side, instead of the exposed end, of the replacement battery pack. Additionally, any of various conventionally known stands may be used with the portable computer to raise the portable computer from the bottom resting surface in order to provide access to the power connector(s) of the replacement battery pack.

It will be appreciated by those skilled in the art that the types of batteries used in the replacement battery packs according to the present invention may be any conventionally known batteries (e.g., secondary batteries) available in the market which meet the requirements of the replacement battery packs. Furthermore, the overall capacity of the battery is selected in accordance with required power requirements of the portable electronic devices with which the replacement battery packs of the present invention are used.

In the foregoing embodiments of the replacement battery pack according to the present invention, the batteries (e.g., secondary batteries) are charged directly by the electrical power supplied by the power source. It will be appreciated, however, that the method and circuitry for charging the batteries of the replacement battery pack are not limited to those specifically disclosed herein. For example, in an alternative embodiment, a capacitor may be connected between the microcontroller and the charge protection circuit of the replacement battery pack. The electric power from the power source for charging the batteries is first stored by the capacitor which in turn charges the batteries. By this construction, since the capacitor can be charged must faster than the batteries, the delivery of the electric power to the replacement battery pack for charging the batteries is expedited so that the power source may be quickly disconnected from the replacement battery pack when a portable electronic apparatus is to be operated directly with power from the batteries in the replacement battery pack.

From the foregoing description, it can be seen that the present invention comprises an improved replacement battery pack, customized AC adapter, and portable electronic device. It will be appreciated by those skilled in the art that obvious changes can be made to the embodiments described in the foregoing description without departing from the broad inventive concept thereof. It is understood, therefore, that this invention is not limited to the particular embodiments disclosed, but is intended to cover all obvious modifications thereof which are within the scope and the spirit of the invention as defined by the appended claims.

1. A replacement battery pack for an electronic device, the replacement battery pack comprising:
a power storage section having a secondary battery;
a power input section having at least one power connector for receiving electric power for charging the secondary battery while powering an electronic device;
a power output/input section comprising a single terminal functioning as having an output terminal for receiving electric power from the power input section and for supplying the electric power to the electronic device when the single terminal is connected to a connector of the electronic device, and functioning as an input terminal for for charging the secondary battery by the electric power from the power input section when the single terminal is connected to the connector of the electronic device and for charging the secondary battery when the single terminal is connected to an external power source while the single output terminal is disconnected from the connector of the electronic device; and
an input power switch circuit for selectively inputting electric power to the power output/input section either from the power input section when the electric power is available therefrom or from the power storage section when the electric power is unavailable from the power input section.

2. A replacement battery pack according to claim 1; wherein the power connector of the power input section receives electric power either from an external direct current power source or a direct current power source converted from an external alternating current power source.

3. A replacement battery pack according to claim 1; wherein the at least one power connector comprises a first power connector for receiving electric power either from an external direct current power source or a direct current power source converted from an external alternating current power source, and a second connector for receiving electric power directly from an alternating current power source.

4. A replacement battery pack according to claim 1; further comprising an output/input control circuit for producing a power output at the output terminal of the power output/input section for powering the electronic device, and for producing a power input at the input terminal of the power output/input section for charging the secondary battery.

5. A replacement battery pack according to claim 1; further comprising a protection circuit for protecting the secondary battery by terminating a charge or discharge operation or disconnecting a charge or discharge operation when abnormal voltage and/or temperature is detected in the secondary battery.

6. A replacement battery pack according to claim 1; further comprising an indicator for indicating remaining power in the secondary battery.

7. In combination: a replacement battery pack according to claim 1; and an alternating current adapter for supplying a direct current power for charging the secondary battery while powering the electronic device by converting an alternating current power input into the alternating current adapter, the alternating current adapter having an alternating current plug for connection to an alternating current power source, a direct current plug for connection to the power connector of the power input section of the replacement battery pack, and a charge detecting circuit for detecting a charge state of the secondary battery in the replacement battery pack when the alternating current plug and the direct current plug are connected to the alternating current power source and the power connector, respectively.

8. A combination according to claim 7; wherein the alternating current adapter has a display for displaying a charge state of the secondary battery detected by the charge detecting circuit.

9. A combination according to claim 7; wherein the replacement battery pack has an indicator for indicating remaining power in the secondary battery and a microcontroller for receiving a signal corresponding to the remaining power in the secondary battery; and wherein the microcontroller outputs a signal to the power connector of the replacement battery pack so that when the direct current plug of the alternating current adapter is connected to the power connector, the charge detecting circuit detects the charge state of the secondary battery in accordance with the remaining power indicated by the indicator of the replacement battery pack.

10. A portable electronic device comprising:
a main body;
a battery pack for supplying power to the portable electronic device;
a battery pack receiving bay formed in the main body for removably housing the battery pack, the battery pack receiving bay having a connector electrically connectable to the battery pack; and
a replacement battery pack configured to be housed within or detached from the battery pack receiving bay, the replacement battery pack and comprising a power storage section having a secondary battery, a power input section having at least one power connector for receiving electric power for charging the secondary battery, and a power output section having an output terminal for receiving electric power from the power input section and for electrical connection to the connector of the battery pack receiving bay when the replacement battery pack is housed in the battery pack receiving bay to power the portable electronic device.

11. A portable electronic device according to claim 10; wherein the portable electronic device comprises a portable computer.

12. A portable electronic device according to claim 10; wherein the at least one power connector of the power input section comprises a plurality of power connectors for receiving electric power either form an external direct current power source or a direct current power source converted from an external alternating current power source.

13. A portable electronic device according to claim 10; wherein the power output section of the replacement battery pack has an input terminal for charging the secondary battery by the electric sower from the input section when the replacement battery pack is housed in the battery pack receiving bay and for charging the secondary battery when the input terminal is connected to an external power source to charge the secondary battery while the replacement battery pack is detached from the battery pack receiving bay.

14. A portable electronic device according to claim 13; further comprising an output/input control circuit for producing a power output at the output terminal of the power output section for powering the portable electronic device, and for producing a power input at the input terminal of the power output section for charging the secondary battery.

15. A portable electronic device according to claim 10; wherein the replacement battery pack has a protection circuit for protecting the secondary battery by terminating a charge or discharge operation or disconnecting a charge or discharge operation when abnormal voltage and/or temperature is detected in the secondary battery.

16. A portable electronic device according to claim 10; wherein the replacement battery pack has an indicator for indicating remaining power in the secondary battery.

17. In combination: portable electronic device according to claim 10; and an alternating current adapter for supplying a direct current power for charging the secondary battery of the replacement battery pack while powering the portable electronic device by converting an alternating current power input into the alternating current adapter, the alternating current adapter having an alternating current plug for connection to an alternating current power source, a direct current plug for connection to the power connector in the power input section of the replacement battery pack, and a charge detecting circuit for detecting a charge state of the secondary battery in the replacement battery pack when the alternating current plug and the direct current plug are connected to the alternating current power source and the power connector, respectively.

18. A combination according to claim 17; wherein the alternating current adapter has a display for displaying a charge state of the secondary battery detected by the charge detecting circuit.

19. A replacement battery pack comprising:
a power storage section having a secondary battery;
a power input section including an alternating current power cord having an electrical plug at a first end for connection to an external alternating current power source and an electrical connector at a second end opposite the first end, an alternating current/direct current converter circuit connected to the electrical connector of the electrical plug for converting external alternating current power from the external alternating current power source to direct current power for charging the battery, and a reel on which the alternating current power cord is adapted to be wound and from which the alternating current power cord is adapted to be dispensed; and
a power output/input section comprising a single terminal functioning as an output terminal for receiving electric power from the power input section and for supplying the electric power to an electronic device when the single terminal is connected to a connector of the electronic device, and functioning as an input terminal for directly charging the secondary battery when the single terminal is connected to an external power source while the single terminal is disconnected from the connector of the electronic device.

20. (canceled)

21. A replacement battery pack according to claim 19; wherein the power input section further comprises at least one power connector for receiving electric power for charging the secondary battery while powering the portable electronic device.

22. A portable electronic device according to claim 13; wherein the power output section comprises a single terminal functioning as both the output terminal and the input terminal.

23. An electronic device comprising:
a main body;
a battery pack for supplying power to the electronic device;
a battery pack receiving bay formed in the main body for housing the battery pack, the battery pack receiving bay having a connector electrically connectable to the battery pack; and
a replacement battery pack according to claim 19 configured to be housed within or detached from the battery pack receiving bay, the single terminal of the power output/input section being connected to the connector of the battery pack receiving bay when the replacement battery pack is housed in the battery pack receiving bay and functioning as the output terminal to supply the electric power to the electronic device.

24. An electronic device according to claim 23; wherein the electronic device comprises a portable electronic device.

25. An electronic device according to claim 24; wherein the portable electronic device comprises a portable computer.

26. In combination with an electronic device having a battery pack receiving bay for removably receiving a battery pack and having a connector disposed within the battery pack receiving bay for electrical connection with the battery pack for supplying electrical power to the electronic device, a replacement battery pack configured to be disposed in or removed from the battery pack receiving bay, the replacement battery pack comprising:
a power storage section having a secondary battery;
a power input section having at least one power connector for receiving electric power for charging the secondary battery while powering the electronic device when the replacement battery pack is disposed in the battery pack receiving bay;
a power output/input section having an output terminal for receiving electric power from the power input section and for electrical connection to the connector of the electronic device disposed within the battery pack receiving bay to power the electronic device when the replacement battery pack is disposed in the battery pack receiving bay, and an input terminal for connection to an external power source to directly charge the secondary battery while the output terminal is disconnected from the connector of the electronic device disposed within the battery pack receiving bay when the replacement battery pack is removed from the battery pack receiving bay; and
an input power switch circuit for selectively inputting electric power to the power output/input section either from the power input section when the electric power is available therefrom or from the power storage section when the electric power is unavailable from the power input section.

27. A combination according to claim 26; wherein the power output section comprises a single terminal functioning both as the output terminal when the replacement battery pack is disposed in the battery pack receiving bay and as the input terminal when the replacement battery pack is removed from the battery pack receiving bay.

28. A combination according to claim 26; wherein the electronic device comprises a portable electronic device.

29. A combination according to claim 28; wherein the portable electronic device comprises a portable computer.

30. A combination according to claim 26; further comprising an output/input control circuit for producing a power output at the output terminal of the power output/input section for powering the electronic device, and for producing a power input at the input terminal of the power output/input section for charging the secondary battery.

31. A combination according to claim 26; wherein the electronic device has a power connector separate and independent from the power connector of the power input section of the replacement battery pack for connection thereto of a power source to supply electrical power for powering the electronic device while charging the secondary battery of the replacement battery pack when the replacement battery pack is disposed in the battery pack receiving bay.
